(19) United States
(12) Patent Application Publication
(10) Pub. No.: US 2007/0181368 A1
(43) Pub. Date: Aug. 9, 2007

(54) STEP LADDER

(75) Inventor: Dennis Simpson, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: TRICAM INTERNATIONAL, INC., Eden Prairie, MN (US)

(21) Appl. No.: 11/671,521

(22) Filed: Feb. 6, 2007

Related U.S. Application Data
(63) Continuation of application No. 11/441,813, filed on May 26, 2006, now Pat. No. 7,188,706.
Application No. 11/441,813 is a division of application No. 10/390,550, filed on Mar. 17, 2003, now Pat. No. 7,128,187.
(60) Provisional application No. 60/364,893, filed on Mar. 15, 2002.

(51) Int. Cl. E06C 1/00

(52) U.S. Cl. 182/165; 182/129

(57) ABSTRACT

A step ladder, includes a first ladder frame and a second ladder frame operably pivotably coupled to the first frame intermediate the second ladder frame, the second ladder frame being formed of a unitary loop defining a step portion and a handle section, the step portion and a handle section being coupled a first bend and a second generally reverse bend. A method of forming a step ladder is further included.

### REFERENCE TO RELATED APPLICATION

The present application is a continuation application of U.S. patent application Ser. No. 11/441,813, filed May 26, 2006, which is a divisional application of U.S. patent application Ser. No. 10/390,550, filed Mar. 17, 2003, now U.S. Pat. No. 7,128,187 B2, issued Oct. 31, 2006 and claims the benefit of U.S. Provisional Patent Application No. 60/364,893, filed Mar. 15, 2002, each hereby incorporated by reference.

### BACKGROUND OF THE INVENTION

Step ladders are generally known in the art. Kummerlin, U.S. Pat. No. 4,502,564, discloses a foldable step ladder. Because of their desired portability, foldable step ladders often include handles and other features that make them easier to transport. Lucci, U.S. Pat. No. 3,744,591, discloses a portable, folding step ladder.

When working on a step ladder, it is often desirable to have tools, paint and other necessary objects within easy reach. For example, it is known to removably attach a paint roller tray to the rung of a ladder to more easily paint a ceiling or other area requiring a ladder or step stool. Golden, U.S. Pat. No. 3,625,388, discloses a paint tray particularly useful with an upright ladder.

Utility trays for use with step ladders are also known in the art. Pham, U.S. Pat. No. 5,673,885, discloses a paint tray for a step ladder for storing work materials, tools and a paint bucket that is held onto the ladder by retaining means. Melanson, U.S. Pat. No. 5,613,574, discloses a ladder mounted tool holster and parts tray that removably clamps onto the top step of a step ladder. Katz et al., U.S. Pat. No. 6,443,260, discloses a step ladder tray pivotally attached to the top cap of a step ladder for supporting tools and the like. Christ et al., U.S. Pat. No. 5,052,581, discloses a detachable ladder support tray for supporting tools and paint containers.

It is often inconvenient, however, to use a removable tool or paint tray with a step ladder. In some instances, the tray may be difficult to attach or remove from the step ladder. The removable tray and step ladder usually must be stored separately, taking up additional space. Additionally, to move a step ladder from place to place, the tray may need to be removed and carried separately because of weight or awkward transport configuration. Further, a means of steadying oneself when mounted on the step ladder is important for safe use of the tools, etc. disposed in the tray.

There is a need in the industry to have an erect handle section for supporting the tray and for supporting the user of the step ladder.

### FIELD OF THE INVENTION

The present invention relates generally to ladders. More particularly, the present invention relates to a step ladder.

### SUMMARY OF THE INVENTION

The present invention substantially meets the aforementioned needs of the industry. By providing two bends in a ladder frame, a handle section that is erect when the step ladder is in the open disposition may be readily formed. A frame of the ladder of the present invention has a pair of side posts and an upper handle section that extends between the pair of side posts. The upper handle section extends sufficiently above steps on the ladder portion so that the upper handle section may by used to steady a person using the step ladder, thereby allowing the user to safely, even when disposed on the top step. Further, the handle section may be used to support the tray.

The present invention is a step ladder, including a first ladder frame and a second ladder frame operably pivotably coupled to the first frame intermediate the second ladder frame, the second ladder frame being formed of a unitary loop defining a step portion and a handle section, the step portion and a handle section being coupled a first bend and a second generally reverse bend. The present invention is further a method of forming a step ladder.

### BRIEF DESCRIPTION OF THE DRAWINGS

FIG. 1 is a side view of a step ladder with ladder portion and a utility tray according to the present invention where the ladder portion is in an open position and the utility tray is in an extended position.

FIG. 2 is a perspective view of the step ladder where the ladder portion is in the open utility tray position and in a storage position.

FIG. 3 is a front view of the step ladder where the ladder portion is in a closed position and the utility tray is in the storage position.

FIG. 4 is an enlarged view of an upper surface of the utility tray.

FIG. 5 is an enlarged view of a lower surface of the utility tray.

FIG. 6 is an enlarged side view of the utility tray in the extended position.

FIG. 7 is an enlarged side view of a slide track on the utility tray.

FIG. 8 is an enlarged side view of the slide track where the utility tray is in a partially lowered position.

### DETAILED DESCRIPTION OF THE PREFERRED EMBODIMENTS

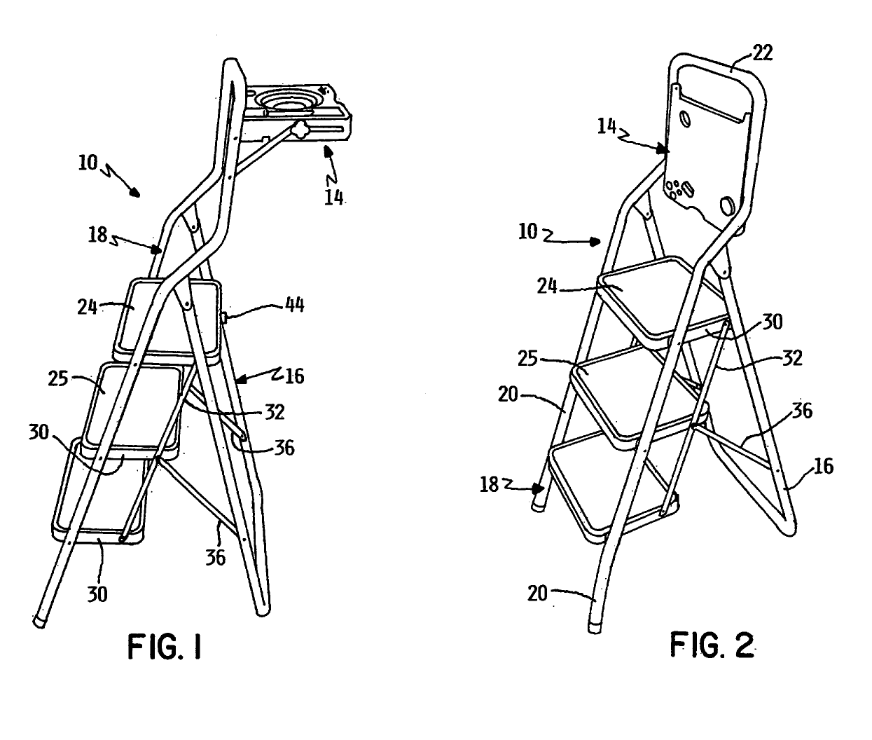

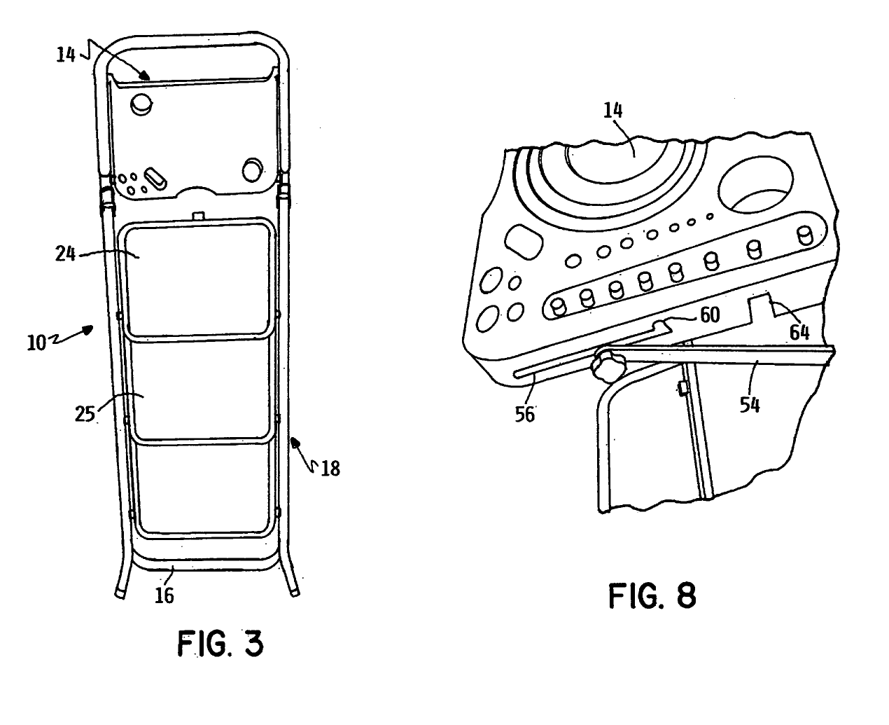

The present invention is a step ladder 10 having a ladder portion 12 and a utility tray 14, as illustrated in FIGS. 1-3. The ladder portion 12 includes a first frame 16 that is pivotally attached to second frame 18. The utility tray 14 is pivotable with respect to the ladder portion 12 between a generally horizontal extended position, as illustrated in FIG. 1, and a generally vertical storage position, as illustrated in FIGS. 2 and 3. The utility tray 14 is generally positioned in the frame 18 when the utility tray 14 is in the vertical storage position.

With the utility tray 14 in the extended position, tools and other objects placed on the utility tray 14 may be easily and conveniently reached when the step ladder 10 is in use without interfering with the ability of a person to access the ladder portion 12. Alternatively, when the utility tray 14 is pivoted to the storage position, the step ladder 10 may be placed adjacent a wall or other similar structure.

The second frame 18 has a pair of side posts 20 and an upper handle section 22 that extends between the pair of side posts 20. The upper handle section 22 extends sufficiently above steps on the ladder portion 12 so that the upper handle section 22 may by used to steady a person using the step ladder 10.

A first step 24 is operably connected to the first frame 16 and the second frame 18. The first step 24 pivots between an extended position and a retracted position as the step ladder 10 is moved from an open position, as illustrated in FIGS. 1 and 2, and a closed position, as illustrated in FIG. 3. The first step 24 pivots with respect to at least one of the first frame 16 and the second frame 18 as the first frame 16 is pivoted with respect to the second frame 18. A second step 25 is preferably operably connected to the first frame 16 and the second frame 18. The second step 25 pivots with respect to the second frame 18.

Each of the steps 24, 25 has a pair of opposed side surfaces 30. Proximate a front end of the side surfaces 30, each of the steps 24, 25 is pivotally attached to the side posts 20. Proximate a back end of the side surfaces 30, each of the steps 24, 25 is interconnected with a tie bar 32. This configuration permits each of the steps 24, 25 to pivot in unison.

A support bar (not shown) is provided at an intermediate location on the first frame 16. When the step ladder 10 is in the extended position, the first step 24 rests on the support bar to thereby maintain the first step 24 in a substantially horizontal position.

A linkage bar 36 preferably extends between the first frame 16 and the tie bar 32. The linkage bar 36 is preferably attached to a lower portion of the first frame 16. The linkage bar 36 is preferably attached to an intermediate location on the tie bar 32.

The linkage bar 36 causes the first frame 16 to pivot towards the second frame 18 as the first step 24 is pivoted from a substantially horizontal orientation to a vertical orientation. The linkage bar 36 is preferably pivotally attached to the tie bar 32 proximate to where the tie bar 32 attaches to the second step 25.

A lock mechanism 44 is preferably attached to the first step 24. The lock mechanism 44 is preferably an L shaped piece that is pivotally mounted to the first step 24. An end of the lock mechanism 44 engages the support bar 36 and thereby retains the step ladder 10 in the opened position.

The lock mechanism 44 increases the stability of the step ladder 10 by preventing premature folding from the opened position to the closed position. The lock mechanism 44 operates to easily lock the step ladder 10 in the opened position while providing a valuable safety feature that reduces the likelihood of injury to the step ladder user.

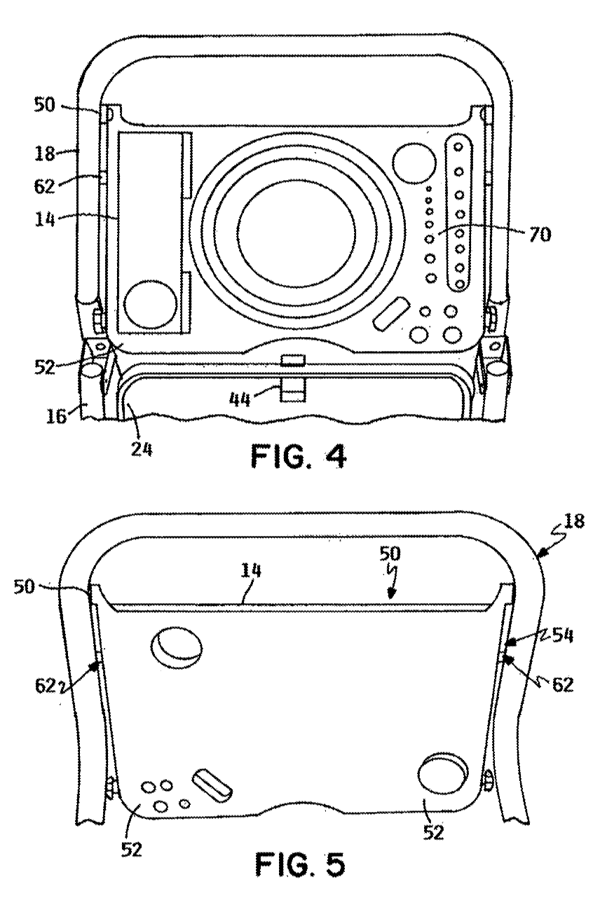

The utility tray 14 has a front end 50 and a rear end 52, as mostly clearly illustrated in FIGS. 4-7. The utility tray 14 is pivotally attached to the second frame 18 proximate the front end 50. A pair of support arms 54 supports the rear end 52. One of the support arms 54 is preferably located on each side panel 55 of the utility tray 14.

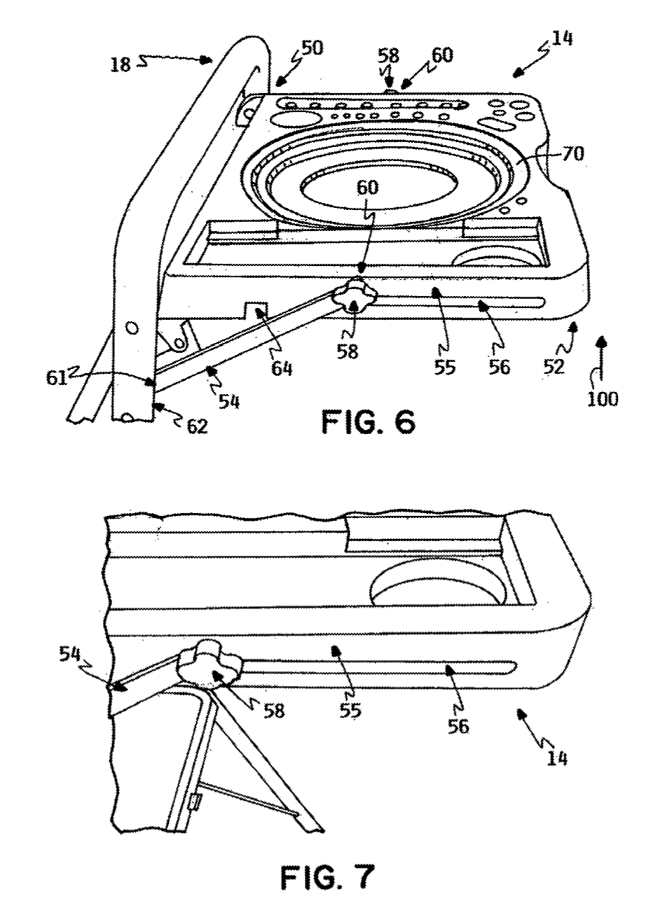

Each side panel 55 of the utility tray 14 preferably has a slot 56 formed 15 therein, as most clearly illustrated in FIGS. 6-8. The slot 56 is generally oriented from the rear end 52 to the front end 50. Proximate a rear end of the slot 56, a detent 60 is provided. An upper end of the support arms 54 at least partially seats in the detent 60 to retain the utility tray 14 in the extended position. As most clearly illustrated in FIG. 9, the detent 60 is preferably oriented at an angle of less than 90 degrees with respect to the slot 56 so that the detent 60 and the slot 56 form a V shape.

When it is desired to move the utility tray 14 from the extended position to the storage position, the rear end 52 is raised slightly so that the support arms 54 move out of the detent 60. Thereafter, the support arms 54 slide in the slots 56 as the rear end 52 is lowered. Knobs 58 are preferably provided at upper ends of the support arms 54 to facilitate operation of the support arms 54.

A first end 61 is proximate to where the support arms 54 pivotally attach to the second frame 18. An inwardly directed extension 62 is preferably provided proximate the first end 61. The inwardly directed extension 62 is located at a second end 63 of the support arms 54. The inwardly directed extension 62 is designed to snugly sit in a recess 64 formed in a side panel 56. Seating of the inwardly directed extension 62 in the recess 64 facilitates maintaining the utility tray 14 in the storage position.

An upper surface 70 of the utility tray 14 is preferably configured to receive paint cans, tools and other items, as illustrated in FIG. 4. Various sized slots for hand tools may be spaced throughout the utility tray 14. Additionally, a plurality of shallow circular depressions may be integrally formed with the utility tray 14 designed to receive and stabilize a variety of paint can sizes. This structure thereby facilitates maintaining items in a desired location on the utility tray 14.

The ladder portion may be folded into a closed position for transport or storage, as illustrated in FIG. 3. With the utility tray 14 and the ladder 12 portion in the closed position, the step ladder 10 may be readily moved from place to place or stored between uses.

To move the utility tray 14 from its generally horizontal extended position to its upright position, upward pressure 100 is applied to the utility tray 14 to disengage the sliding knobs 68 from the detents 60. Continuous downward pressure on the sliding knobs 68 causes them to slide within the slots 56 and lowers the utility tray 14 until the securing knobs 68 are fit securely into the recesses 64.

In an alternative embodiment, extensions may be operably connected to the first frame 16 and the second frame 18.

It is contemplated that features disclosed in this application, as well as those described in the above applications incorporated by reference, can be mixed and matched to suit particular circumstances. Various other modifications and changes will be apparent to those of ordinary skill.

What is claimed is:

1. A step ladder, comprising:
a first ladder frame;
a second ladder frame operably pivotably coupled to the first frame intermediate the second ladder frame, the second ladder frame having a step portion and a handle section, the handle section being coupled to the step portion proximate a first bend and a second generally reverse bend formed in the handle section.

2. The step ladder of claim 1, the handle section being formed in a loop, the loop coupling two spaced apart side rails of the second ladder frame.

3. The step ladder of claim 1, the first ladder frame and the second ladder frame being selectively shiftable between a closed disposition and an open disposition, the handle section being in a generally vertical disposition when the first ladder frame and the second ladder frame are upright in the open disposition.

4. The step ladder of claim 1, further including a utility tray pivotably coupled to the handle section.

5. The step ladder of claim 4, the utility tray have plurality of concentric depressions defined therein.

6. The step ladder of claim 4, the utility tray being shiftable between a storage disposition and an extended disposition.

7. The step ladder of claim 4, the utility tray depending from pivots when in the storage disposition.

8. The step ladder of claim 1, further including a shiftable linkage operably coupled to the first ladder frame for supporting in part each of a plurality of ladder steps.

9. A method of forming a step ladder, comprising:
forming a first ladder frame;
forming a second ladder frame and operably pivotably coupling the second ladder frame to the first frame intermediate the second ladder frame, forming the second ladder frame with a step portion and a handle section, coupling the handle section to the step portion proximate a first bend and a second generally reverse bend formed in the handle section.

10. The method of claim 9, including forming the handle section in a loop, coupling two spaced apart side rails of the second ladder frame by means of the loop.

11. The method of claim 9, including selectively shifting the first ladder frame and the second ladder frame between a closed disposition and an open disposition and disposing the handle section being in a generally vertical disposition when the first ladder frame and the second ladder frame are upright in the open disposition.

12. The method of claim 9, further including pivotably coupling a utility tray to the handle section.

13. The method of claim 12, including forming a plurality of concentric depressions in the utility tray.

14. The method of claim 12, including shifting the utility tray between a storage disposition and an extended disposition wherein the utility tray is disposed to receive hand tools and the like.

15. The method of claim 12 including depending the utility tray from pivots when in the storage disposition.

16. The method of claim 9, further including operably coupling a linkage to the first ladder frame and supporting in part a plurality of ladder steps therewith.

17. A step ladder, comprising:
a first ladder frame; and
a second ladder frame operably pivotably coupled to the first frame intermediate the second ladder frame, the second ladder frame being formed of a unitary loop defining a step portion and a handle section, the step portion and a handle section being coupled a first bend and a second generally reverse bend.

18. The step ladder of claim 17, the handle section being formed in a loop, the loop coupling two spaced apart side rails of the second ladder frame.

19. The step ladder of claim 17, the first ladder frame and the second ladder frame being selectively shiftable between a closed disposition and an open disposition, the handle section being in a generally vertical disposition when the first ladder frame and the second ladder frame are upright in the open disposition.

20. The step ladder of claim 17, further including a shiftable linkage operably coupled to the first ladder frame for supporting in part each of a plurality of ladder steps.
